(19) United States
(12) Patent Application Publication
(10) Pub. No.: US 2014/0355593 A1
(43) Pub. Date: Dec. 4, 2014

(54) AP Response Method, AP Discovery Method, AP and Terminal

(71) Applicant: Huawei Device Co., Ltd., Shenzhen (CN)

(72) Inventors: Xin Guan, Shenzhen (CN); Zhiming Ding, Shenzhen (CN); Ping Fang, Shenzhen (CN)

(21) Appl. No.: 14/460,981

(22) Filed: Aug. 15, 2014

Related U.S. Application Data
(63) Continuation of application No. PCT/CN2013/073529, filed on Mar. 30, 2013.

(30) Foreign Application Priority Data
Mar. 30, 2012 (CN) 201210090283.4

(51) Int. Cl. H04W 48/18; H04W 84/12; H04W 88/08; H04W 8/02

(52) U.S. Cl. CPC H04W 48/18; H04W 8/02; H04W 84/12; H04W 88/08
USPC 370/338

(57) ABSTRACT

An access point (AP) response method including receiving, by an AP, a probe request message and allowing to a probe response message to be returned to the terminal when a roaming agreement is signed. According to this invention, only an AP instead of all APs on a network needs to return the probe response message to the terminal, a same network roaming agreement is signed between the network in which the AP is located and a network in which the terminal is located. Therefore, network resources are saved. In addition, it avoids that the terminal processes the probe response message returned by the AP for which the network roaming agreement is not signed, thereby reducing time for discovering the AP by the terminal, and increasing a network access speed of the terminal accordingly.

### CROSS-REFERENCE TO RELATED APPLICATION

This application is a continuation of International Application PCT/CN2013/073529, filed on Mar. 30, 2013, which claims priority to Chinese Patent Application No. 201210090283.4, filed on Mar. 30, 2012, both of which are hereby incorporated by reference in their entireties.

### TECHNICAL FIELD

The present invention relates to the field of communications technologies, and in particular, to an access point (AP) response method, an AP discovery method, an AP, and a terminal.

### BACKGROUND

Existing terminals, such as laptop computers, Personal Digital Assistants (PDAs), and mobile phones, all support the Wireless Fidelity (WiFi) technology. Terminals access a WiFi network by using APs deployed in different locations, where the AP is a wireless access device. On the WiFi network, each AP may support access of a plurality of terminals, which are also referred to as stations. Currently, each terminal supports a network roaming agreement of a telecommunications service provider. Therefore, the terminal can access the WiFi network by using an AP for which the network roaming agreement is signed with the telecommunications service provider. Because the WiFi network includes APs that have signed different network roaming agreements, the terminal needs to select a corresponding AP to establish a connection, to access the WiFi network.

Currently, when a terminal needs to access a WiFi network, the terminal sends a Probe Request message to the network side, where a Service Set Identifier (SSID) field in the probe request message is set to a wildcard or a specified network character. When the SSID field is set to the wildcard, all APs on a network that receive this probe request message return a probe response message to the terminal; and when the SSID field is set to the specified network character, only an AP deployed on the network corresponding to the network character returns probe response information. When a network roaming agreement is signed for the terminal, the probe response message sent by the AP carries information about the network roaming agreement signed by the AP that sends the probe response message. The terminal analyzes the information in the received probe response message and performs further authentication association with the AP.

When the terminal for which the network roaming agreement is signed selects to an AP to access the network, because all APs on the network need to return a probe response message to the terminal, the probe response messages transmitted by all the APs exist on the network, resulting in a network resource waste; in addition, because the terminal needs to process a plurality of the received probe response messages, time for discovering the AP is prolonged, and a network access speed of the terminal is decreased accordingly.

### SUMMARY

Embodiments of the present invention provide an AP response method, an AP discovery method, an AP, and a terminal, so as to reduce network resource usage and increase access speeds during a network access process of a terminal.

To resolve the foregoing technical problems, the embodiments of the present invention disclose the following technical solutions:

An AP response method is provided, where the method includes receiving, by an AP, a probe request message sent by a terminal, where the probe request message includes network roaming indication information, and the network roaming indication information includes home location network indication information of the terminal, and allowing, by the AP, to return a probe response message to the terminal when a roaming agreement is signed between a network indicated by the home location network indication information of the terminal and a network in which the AP is located.

An AP discovery method is provided, where the method includes sending, by a terminal, a probe request message, where the probe request message includes network roaming indication information, and the network roaming indication information includes home location network indication information of the terminal, receiving a probe response message returned by the AP, where a roaming agreement is signed between a network in which the AP is located and a network indicated by the home location network indication information of the terminal, and accessing the AP that returns the probe response message.

An AP is provided, where the AP includes a receiving unit configured to receive a probe request message sent by a terminal, where the probe request message includes network roaming indication information, and the network roaming indication information includes home location network indication information of the terminal, and a responding unit configured to allow to send a probe response message to the terminal when a roaming agreement is signed between a network indicated by the home location network indication information of the terminal and a network in which the AP is located.

A terminal is provided, where the terminal includes a sending unit configured to send a probe request message, where the probe request message includes network roaming indication information, and the network roaming indication information includes home location network indication information of the terminal, and a receiving unit configured to receive a probe response message returned by an AP, where a roaming agreement is signed between a network in which the AP is located and a network indicated by the home location network indication information of the terminal.

According to the embodiments of the present invention, an AP receives a probe request message sent by a terminal, where the probe request message includes network roaming indication information, and the network roaming indication information includes home location network indication information of the terminal, and when a roaming agreement is signed between a network indicated by the home location network indication information of the terminal and a network in which the AP is located, the AP is allowed to return a probe response message to the terminal, so that the terminal can discover the AP. Because the network roaming indication information in the probe request message carries the home location network indication information of the terminal during AP discovery of the terminal in the embodiments of the present invention, only an AP instead of all APs on a network needs to return the probe response message to the terminal, where a same network roaming agreement is signed between the network in which the AP is located and a network in which the terminal is located. Therefore, network resources are saved. In addition, it avoids that the terminal processes the probe response messages returned by the APs for which the network roaming agreement is not signed, thereby reducing time for discovering the AP by the terminal, and increasing a network access speed of the terminal accordingly.

### BRIEF DESCRIPTION OF DRAWINGS

To describe the technical solutions in the embodiments of the present invention more clearly, the following briefly introduces the accompanying drawings required for describing the embodiments. A person of ordinary skill in the art may still derive other drawings from these accompanying drawings without creative efforts.

FIG. 1 is a flowchart of an AP response method according to a first embodiment of the present invention;

FIG. 2 is a flowchart of an AP response method according to a second embodiment of the present invention;

FIG. 3 is a flowchart of an AP response method according to a third embodiment of the present invention;

FIG. 4 is a flowchart of an AP response method according to a third embodiment of the present invention;

FIG. 5 is a flowchart of an AP discovery method according to an embodiment of the present invention;

FIG. 6 is a block diagram of an embodiment of an AP according to the present invention; and

FIG. 7 is a block diagram of an embodiment of a terminal according to the present invention.

### DESCRIPTION OF EMBODIMENTS

The following embodiments of the present invention provide an AP response method, an AP discovery method, an AP, and a terminal.

To enable persons skilled in the art to better understand the technical solutions in the embodiments of the present invention and make the foregoing objectives, characteristics, and advantages of the present invention more comprehensible, the following describes the technical solutions of the present invention in more detail with reference to accompanying drawings.

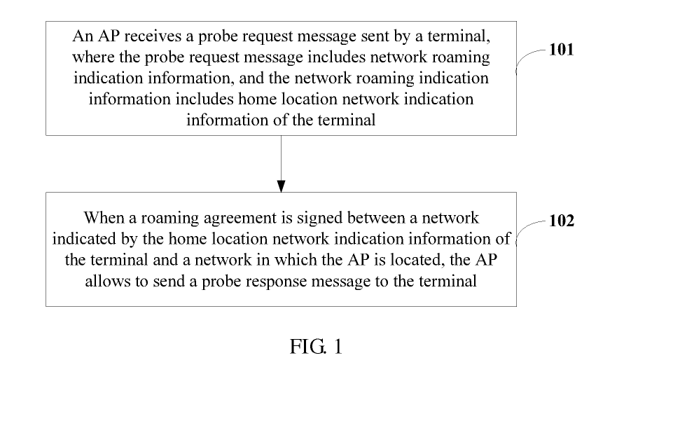

Referring to FIG. 1, FIG. 1 is a flowchart of an AP response method according to a first embodiment of the present invention.

Step 101: An AP receives a probe request message sent by a terminal, where the probe request message includes network roaming indication information, and the network roaming indication information includes home location network indication information of the terminal.

The terminal may include a SSID in the probe request message, where the SSID includes identifier information of a home location network of the terminal, or may also include the SSID in the probe request message, where the SSID includes the identifier information of the home location network of the terminal and a roaming indication; or may also include a roaming network information element in the probe request message, where the roaming network information element includes the identifier information of the home location network of the terminal.

Step 102: When a roaming agreement is signed between a network indicated by the home location network indication information of the terminal and a network in which the AP is located, the AP is allowed to return a probe response message to the terminal.

“Roaming” is a feature that enables a user to still enjoy a communications service after leaving a subscribed home location network and accessing another network. The roaming agreement in this embodiment refers to an agreement made between network service providers. When a terminal leaves the home location network and accesses another network, the other network can provide a service for the terminal if a roaming agreement is signed between the other network and the home location network.

When the probe request message received in step 101 includes the SSID and the SSID includes the identifier information of the home location network of the terminal, the AP reads the SSID in the probe request message, acquires the identifier information of the home location network of the terminal from the SSID, and checks whether a roaming agreement is signed between the network indicated by the identifier information of the terminal and the network in which the AP is located when it is determined according to the identifier information that the AP does not belong to the home location network of the terminal. When the roaming agreement is signed between the network indicated by the identifier information of the terminal and the network in which the AP is located, the AP is allowed to send the probe response message to the terminal.

When the probe request message received in step 101 includes the SSID and the SSID includes the identifier information of the home location network of the terminal and the roaming indication, the AP reads the SSID in the probe request message, acquires the identifier information of the home location network of the terminal and the roaming indication from the SSID, and triggers, according to the acquired roaming indication, a comparison for whether a roaming agreement is signed between the network indicated by the identifier information of the terminal and the network in which the AP is located. When the roaming agreement is signed between the network indicated by the identifier information of the terminal and the network in which the AP is located, the AP is allowed to send the probe response message to the terminal.

When the probe request message received in step 101 includes the roaming network information element and the roaming network information element includes the identifier information of the home location network of the terminal, the AP reads the network information element in the probe request message, acquires the identifier information of the home location network of the terminal from the network information element, and checks whether a roaming agreement is signed between the network indicated by the identifier information of the terminal and the network in which the AP is located. When the roaming agreement is signed between the network indicated by the identifier information of the terminal and the network in which the AP is located, the AP is allowed to send the probe response message to the terminal.

It should be noted that, after the AP is allowed to send the probe response message to the terminal, the AP may directly return the probe response message to the terminal, or the AP may return the probe response message to the terminal again after another preset condition is met.

It can be learned from the foregoing embodiment, because network roaming indication information in a probe request message carries home location network indication information of a terminal during AP discovery of the terminal, only an AP instead of all APs on a network needs to return the probe response message to the terminal, where a same network roaming agreement is signed between the network in which the AP is located and a network in which the terminal is located. Therefore, network resources are saved. In addition, it avoids that the terminal processes the probe response messages returned by the APs for which the network roaming agreement is not signed, thereby reducing time for discovering the AP by the terminal, and increasing a network access speed of the terminal accordingly.

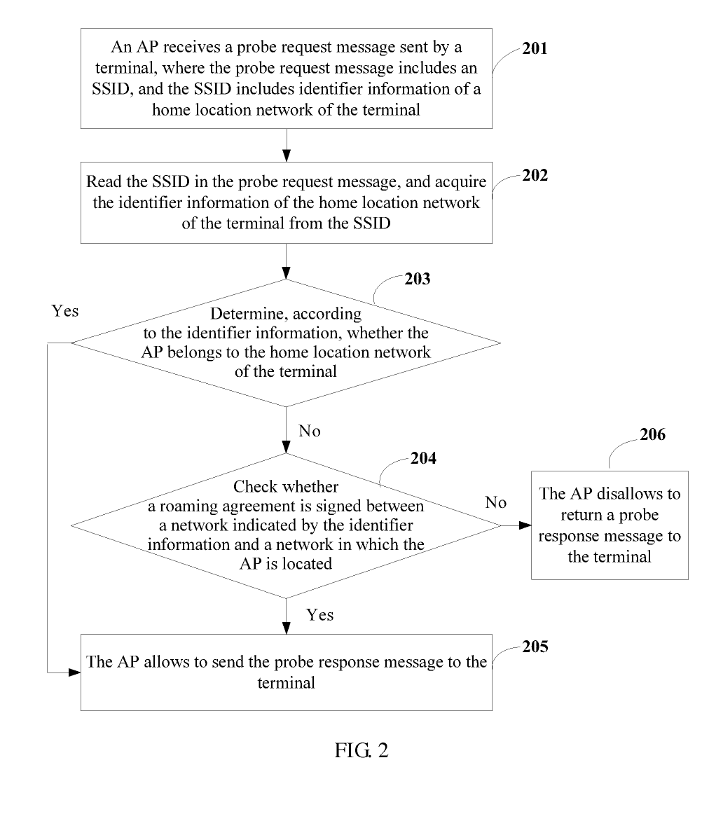

Referring to FIG. 2, FIG. 2 is a flowchart of a second embodiment of an AP response method according to the present invention. This embodiment illustrates an AP response process according to identifier information of a home location network of a terminal included in a SSID in a probe request message.

Step 201: An AP receives a probe request message sent by a terminal, where the probe request message includes a SSID and the SSID includes identifier information of a home location network of the terminal.

The SSID is an information element included in an existing probe request message, and information that can be included in a SSID field in the SSID in an existing mechanism includes a specified network name (for example, a WiFi network deployed by China Unicom can be written as “China Unicom”), and China Unicom is a telecom operator, a specified network identification (ID) (for example, the WiFi network deployed by China Unicom can be written as “46001”), and a WiFi network name (for example, a hotspot deployed by Kentucky Fried Chicken can be named “KFC”), and a wildcard (“*” is used to indicate any network).

In this embodiment, the identifier information of the home location network of the terminal included in the SSID field of the SSID may be a specified network name or a specified network ID. In addition to the SSID field, the SSID further includes a SSID name and a SSID length.

As shown in the following Table 1, Table 1 is a schematic diagram of a format of a type of SSID in a probe request message, where identifier information included in a SSID field is character information of a home location network of a terminal.

TABLE 1
SSID

| | | |
|---|---|---|
| Element ID | Length | China Unicom |
| (SSID name) | (SSID length) | (SSID field) |

As shown in the foregoing Table 1, a character name of the home location network of the terminal is set in the SSID field, that is, the character name indicates a network in which the terminal is located. For example, if the home location network of the terminal is a network of China Unicom, the SSID field is set to “China Unicom” shown in the foregoing Table 1. In this embodiment, this setting is further used to subsequently enable the AP to be allowed to return a probe response message to the terminal when it is determined that a roaming agreement is signed between the home location network of the terminal and the network in which the AP is located.

As shown in the following Table 2, Table 2 is a schematic diagram of a format of another type of SSID in the probe request message, where the identifier information included in the SSID field is ID information of the home location network of the terminal.

TABLE 2
SSID

| | | |
|---|---|---|
| Element ID | Length | 46001 |
| (SSID name) | (SSID length) | (SSID field) |

As shown in the foregoing Table 2, a network ID of the home location network of the terminal is set in the SSID field, that is, the network ID indicates the network in which the terminal is located. For example, if the home location network of the terminal is the network of China Unicom, the SSID field is set to “46001” shown in the foregoing Table 2. In this embodiment, this setting is further used to subsequently enable the AP to be allowed to return the probe response message to the terminal when it is determined that the roaming agreement is signed between the home location network of the terminal and the network in which the AP is located. The network ID is defined by using a definition manner of an International Mobile Subscriber Identification Number (IMSI) and includes five digits in total, that is, a protocol ID includes a mobile country code (MCC), a mobile network code (MNC), and a random value, where the MCC identifies a country to which the terminal belongs and is formed by three digits (for example, 460 for China), and the MNC identifies a mobile network public land mobile network (PLMN) to which the terminal belongs and is formed by two digits (for example, 01 for a digital shared cellular mobile communications network of China Unicom).

Step 202: Read the SSID in the probe request message, and acquire the identifier information of the home location network of the terminal from the SSID.

It can be learned from the foregoing Table 1 that all APs on the network receive the probe request message sent by the terminal, and each AP reads the character information borne over the SSID field in the probe request message, that is, reads the “China Unicom” borne over the SSID field in Table 1, and it can be learned according to the character “China Unicom” that the home location network of the terminal is the network of China Unicom.

It can be learned from the foregoing Table 2 that all APs on the network receive the probe request message sent by the terminal, and each AP reads the network ID borne over the SSID field in the probe request message, that is, reads the “46001” borne over the SSID field in Table 2, and it can be learned according to the ID “46001” that the home location network of the terminal is the network of China Unicom.

Step 203: Determine whether the AP belongs to the home location network of the terminal according to the identifier information and if yes, perform step 205; otherwise, perform step 204.

After acquiring the identifier information of the home location network of the terminal, the AP determines whether the network in which the AP is located and the home location network of the terminal are the same network. For example, when the home location network of the terminal is the network of China Unicom, the AP needs to determine whether the AP also belongs to the network of China Unicom.

Step 204: Check whether a roaming agreement is signed between the network indicated by the identifier information of the terminal and the network in which the AP is located and if yes, perform step 205; otherwise, perform step 206.

When the AP does not belong to the home location network of the terminal, whether a roaming agreement is signed between the network indicated by the acquired identifier information and the network in which the AP is located is further checked.

In this embodiment, information about a network is saved in each AP, where a network roaming agreement is signed between the network and the network in which the AP is located. For example, the network in which the AP is located is a network A, the networks for which network A has a network roaming agreement signed include a network B and a network C, and the AP saves identifier information of the foregoing network B and network C; therefore, after the identifier information of the home location network of the terminal is acquired, the identifier information of the home location network of the terminal can be searched in the foregoing saved identifier information of network B and network C. If the identifier information of the home location network of the terminal is found, it indicates that a roaming agreement is signed between the network in which the terminal is located and the network in which the AP is located, and if the identifier information of the home location network of the terminal is not found, it indicates that no roaming agreement is signed between the network in which the terminal is located and the network in which the AP is located.

Step 205: The AP is allowed to send a probe response message to the terminal, and the current process ends.

When the roaming agreement is signed between the network indicated by the identifier information of the terminal and the network in which the AP is located, the AP is allowed to send the probe response message to the terminal, so that the terminal receiving the probe response message can discover the AP.

It should be noted that, after the AP is allowed to send the probe response message to the terminal, the AP may directly return the probe response message to the terminal, or the AP may return the probe response message to the terminal again after another preset condition is met.

Step 206: The AP is not allowed to return the probe response message to the terminal, and the current process ends.

When no roaming agreement is signed between the network indicated by the identifier information and the network in which the AP is located, the AP does not return the probe response message to the terminal. Because the terminal does not receive the probe response message sent by the AP, it avoids that the terminal processes the probe response message returned by the AP for which a network roaming agreement is not signed, thereby improving an AP discovery speed of the terminal.

It can be learned from the foregoing embodiment, because a SSID in a probe request message includes identifier information of a home location network of a terminal during AP discovery of the terminal, it is unnecessary that all APs on a network transmit a probe response messages to the terminal, whereas it can be ensured that an AP on the network returns the probe response message, where a same network roaming agreement is signed between the network in which the AP is located and a network in which the terminal is located. Therefore, network resources are saved. In addition, it avoids that the terminal processes the probe response messages returned by the APs for which the network roaming agreement is not signed, thereby reducing time for discovering the AP by the terminal, and increasing a network access speed of the terminal accordingly.

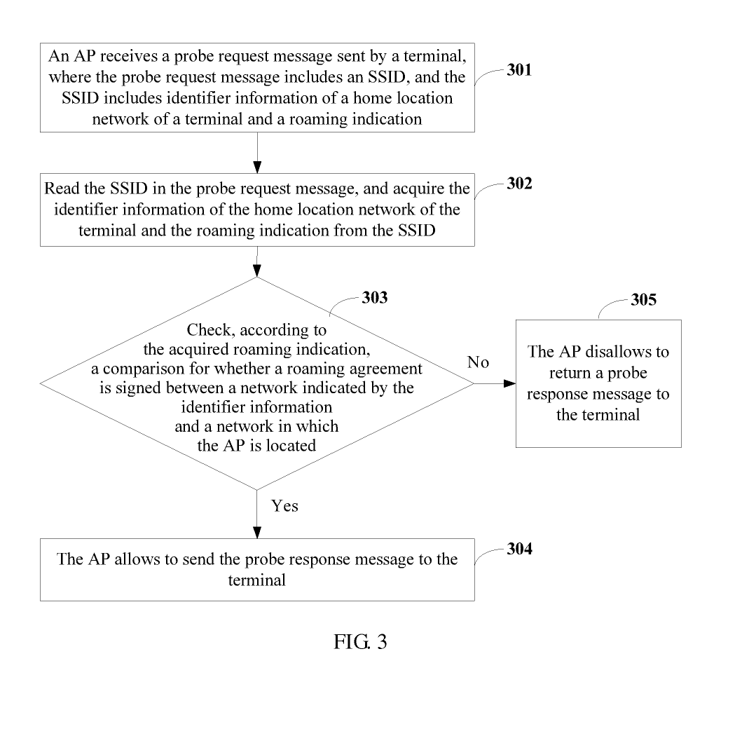

Referring to FIG. 3, FIG. 3 is a flowchart of a third embodiment of an AP response method according to the present invention. This embodiment illustrates an AP response process according to identifier information of a home location network of a terminal and a roaming indication included in a SSID in a probe request message.

Step 301: An AP receives a probe request message sent by a terminal, where the probe request message includes a SSID and the SSID includes identifier information of a home location network of the terminal and a roaming indication.

In this embodiment, the identifier information of the home location network of the terminal included in the SSID field of the SSID may be a specified network name or a specified network ID. In addition to the SSID field, the SSID further includes a SSID name and a SSID length.

As shown in the following Table 3, Table 3 is a schematic diagram of a format of a type of SSID in the probe request message. Character information is used as an example to describe the identifier information included in the SSID field.

TABLE 3
SSID

| | | |
|---|---|---|
| Element ID | Length | *: China Unicom |
| (SSID name) | (SSID length) | (SSID field) |

As shown in the foregoing Table 3, a character name of the home location network of the terminal and the roaming indication are set in the SSID field, that is, the character name indicates a network in which the terminal is located. For example, if the home location network of the terminal is a network of China Unicom, the SSID field is set to “China Unicom” shown in the foregoing Table 3. The roaming indication “*:” is used to subsequently trigger allowing the AP to return a probe response message to the terminal when it is determined that a roaming agreement is signed between the home location network of the terminal and the network in which the AP is located. That is, a difference between this embodiment and the embodiment shown in FIG. 2 lies in that, because the roaming indication is set in this embodiment, the AP does not need to determine whether the AP is located on the home location network in which the terminal is located. In addition, it should be noted that the identifier information in the foregoing Table 3 is described by using the character information as an example. In an actual application, the identifier information may also be a network ID, which is not further described herein.

Step 302: Read the SSID in the probe request message, and acquire the identifier information of the home location network of the terminal and the roaming indication from the SSID.

It can be learned from the foregoing Table 3 that all APs on the network receive the probe request message sent by the terminal, and each AP reads the character information and roaming indication borne over a newly-added information field in the probe request message, that is, reads the “*:China Unicom” borne over the SSID field in Table 3. According to the character “China Unicom”, it can be learned that the home location network of the terminal is the network of China Unicom, and step 303 is triggered according to the “*:” to determine whether a roaming agreement is signed between the home location network of the terminal and the network in which the AP is located.

Step 303: Check whether a roaming agreement is signed between the network indicated by the identifier information of the terminal and the network in which the AP is located according to the acquired roaming indication and if yes, perform step 304; otherwise, perform step 305.

In this embodiment, information about the network is saved in each AP, where a network roaming agreement is signed between the network and the network in which the AP is located. For example, the network in which the AP is located is a network A, the networks for which network A has a network roaming agreement signed include a network B and a network C, and the AP saves identifier information of the foregoing network B and network C; therefore, after the identifier information of the home location network of the terminal is acquired, the identifier information of the home location network of the terminal can be searched in the foregoing saved identifier information of network B and network C. If the identifier information of the home location network of the terminal is found, it indicates that a roaming agreement is signed between the network in which the terminal is located and the network in which the AP is located, and if the identifier information of the home location network of the terminal is not found, it indicates that no roaming agreement is signed between the network in which the terminal is located and the network in which the AP is located.

Step 304: The AP is allowed to send a probe response message to the terminal, and the current process ends.

When the roaming agreement is signed between the network indicated by the identifier information of the terminal and the network in which the AP is located, the AP is allowed to send the probe response message to the terminal, so that the terminal receiving the probe response message can discover the AP.

It should be noted that, after the AP is allowed to send the probe response message to the terminal, the AP may directly return the probe response message to the terminal, or the AP may return the probe response message to the terminal again after another preset condition is met.

Step 305: The AP is not allowed to return the probe response message to the terminal, and the current process ends.

When no roaming agreement is signed between the network indicated by the identifier information and the network in which the AP is located, the AP does not return the probe response message to the terminal. Because the terminal does not receive the probe response message sent by the AP, it avoids that the terminal processes the probe response message returned by the AP for which a network roaming agreement is not signed, thereby improving an AP discovery speed of the terminal.

It can be learned from the foregoing embodiment, because a SSID in a probe request message includes identifier information of a home location network of a terminal and a roaming indication during AP discovery of a terminal, it is unnecessary that all APs on a network transmit probe response messages to the terminal, whereas it can be ensured that an AP on the network returns a probe response message, where a same network roaming agreement is signed between the network in which the AP is located and a network in which the terminal is located. Therefore, network resources are saved. In addition, it avoids that the terminal processes the probe response messages returned by the APs for which the network roaming agreement is not signed, thereby reducing time for discovering the AP by the terminal, and increasing a network access speed of the terminal accordingly.

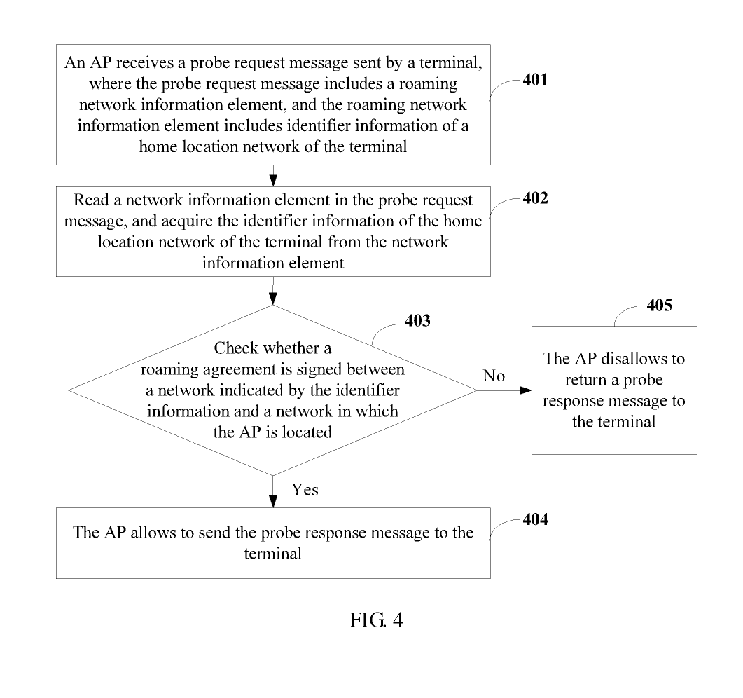

Referring to FIG. 4, FIG. 4 is a flowchart of a fourth embodiment of an AP response method according to the present invention. This embodiment illustrates an AP response process according to identifier information of a home location network of a terminal included in a newly-added roaming network information element in a probe request message.

Step 401: An AP receives a probe request message sent by a terminal, where the probe request message includes a roaming network information element, and the roaming network information element includes identifier information of a home location network of the terminal.

The identifier information of the home location network of the terminal is included in the SSID in the probe request message in the foregoing embodiments shown in FIG. 2 and FIG. 3. In this embodiment, a new roaming network information element is added to the probe request message, and the roaming network information element includes the identifier information of the home location network of the terminal.

In this embodiment, the identifier information of the home location network of the terminal borne over an element field of the newly added roaming network information element may be a specified network name or a specified network ID. In addition to the element field, the roaming network information element further includes an element name and an element length.

As shown in the following Table 4, Table 4 is a schematic diagram of a format of a type of roaming network information element in the probe request message, where the identifier information included in the element field of the roaming network information element is character information of the home location network of the terminal.

TABLE 4
Roaming Network Information Element

| | | |
|---|---|---|
| Element ID | Length | China Unicom |
| (element ID) | (element length) | (element field) |

As shown in the foregoing Table 4, a character name of the home location network of the terminal is set in the element field of the roaming network information element, that is, the character name indicates a network in which the terminal is located. For example, if the home location network of the terminal is a network of China Unicom, the element field of the roaming network information element is set to “China Unicom” shown in the foregoing Table 4. In this embodiment, this setting is further used to subsequently enable the AP to be allowed to return a probe response message to the terminal when it is determined that a roaming agreement is signed between the home location network of the terminal and the network in which the AP is located.

As shown in the following Table 5, Table 5 is a schematic diagram of a format of another type of roaming network information element in the probe request message, where the identifier information included in the element field of the roaming network information element is ID information of the home location network of the terminal.

TABLE 5
Roaming Network Information Element

| | | |
|---|---|---|
| Element ID | Length | 46001 |
| (element ID) | (element length) | (element field) |

As shown in the foregoing Table 5, a network ID of the home location network of the terminal is set in the element field of the roaming network information element, that is, the network ID indicates the network in which the terminal is located. For example, if the home location network of the terminal is the network of China Unicom, the element field of the roaming network information element is set to “46001” shown in the foregoing Table 5. In this embodiment, this setting is further used to subsequently enable the AP to be allowed to return the probe response message to the terminal when it is determined that the roaming agreement is signed between the home location network of the terminal and the network in which the AP is located.

Step 402: Read a network information element in the probe request message and acquire the identifier information of the home location network of the terminal from the network information element.

It can be learned from the foregoing Table 4 that all APs on the network receive the probe request message sent by the terminal, and each AP reads the character information borne over the element field of the roaming network information element in the probe request message, that is, reads the “China Unicom” borne over the element field of the roaming network information element in Table 4, and it can be learned according to the character “China Unicom” that the home location network of the terminal is the network of China Unicom.

It can be learned from the foregoing Table 5 that all APs on the network receive the probe request message sent by the terminal, and each AP reads the network ID borne over the element field of the roaming network information element in the probe request message, that is, reads the “46001” borne over the element field of the roaming network information element in Table 5, and it can be learned according to the ID “46001” that the home location network of the terminal is the network of China Unicom.

Step 403: Check whether a roaming agreement is signed between the network indicated by the identifier information of the terminal and the network in which the AP is located and if yes, perform step 404; otherwise, perform step 405.

In this embodiment, information about the network is saved in each AP, where a network roaming agreement is signed between the network and the network in which the AP is located. For example, the network in which the AP is located is a network A, the networks for which network A has a network roaming agreement signed include a network B and a network C, and the AP saves identifier information of the foregoing network B and network C; therefore, after the identifier information of the home location network of the terminal is acquired, the identifier information of the home location network of the terminal can be searched in the foregoing saved identifier information of network B and network C. If the identifier information of the home location network of the terminal is found, it indicates that a roaming agreement is signed between the network in which the terminal is located and the network in which the AP is located, and if the identifier information of the home location network of the terminal is not found, it indicates that no roaming agreement is signed between the network in which the terminal is located and the network in which the AP is located.

Step 404: The AP is allowed to send a probe response message to the terminal, and the current process ends.

When the roaming agreement is signed between the network indicated by the identifier information of the terminal and the network in which the AP is located, the AP is allowed to send the probe response message to the terminal, so that the terminal receiving the probe response message can discover the AP.

It should be noted that, after the AP is allowed to send the probe response message to the terminal, the AP may directly return the probe response message to the terminal, or the AP may return the probe response message to the terminal again after another preset condition is met.

Step 405: The AP is not allowed to return the probe response message to the terminal, and the current process ends.

When no roaming agreement is signed between the network indicated by the identifier information and the network in which the AP is located, the AP does not return the probe response message to the terminal. Because the terminal does not receive the probe response message sent by the AP, it avoids that the terminal processes the probe response message returned by the AP for which a network roaming agreement is not signed, thereby improving an AP discovery speed of the terminal.

It can be learned from the foregoing embodiment, because a newly added roaming network information element in a probe request message includes identifier information of a home location network of a terminal during AP discovery of the terminal, it is unnecessary that all APs on a network transmit probe response messages to the terminal, whereas it can be ensured that an AP on the network returns a probe response message, where a same network roaming agreement is signed between the network in which the AP is located and a network in which the terminal is located. Therefore, network resources are saved. In addition, it avoids that the terminal processes the probe response messages returned by the APs for which the network roaming agreement is not signed, thereby reducing time for discovering the AP by the terminal, and increasing a network access speed of the terminal accordingly.

Corresponding to the foregoing AP response method embodiments, the present invention further provides an embodiment of an AP discovery method. The embodiments of the foregoing AP response method describe a process, on the AP side, in which the AP returns the probe response message to the terminal according to the received probe request message only when a network roaming agreement is signed between a network in which the AP is located and a network in which the terminal is located. The following embodiment of the AP discovery method describes a process, on the terminal side, in which the terminal discovers the AP that returns the probe response message.

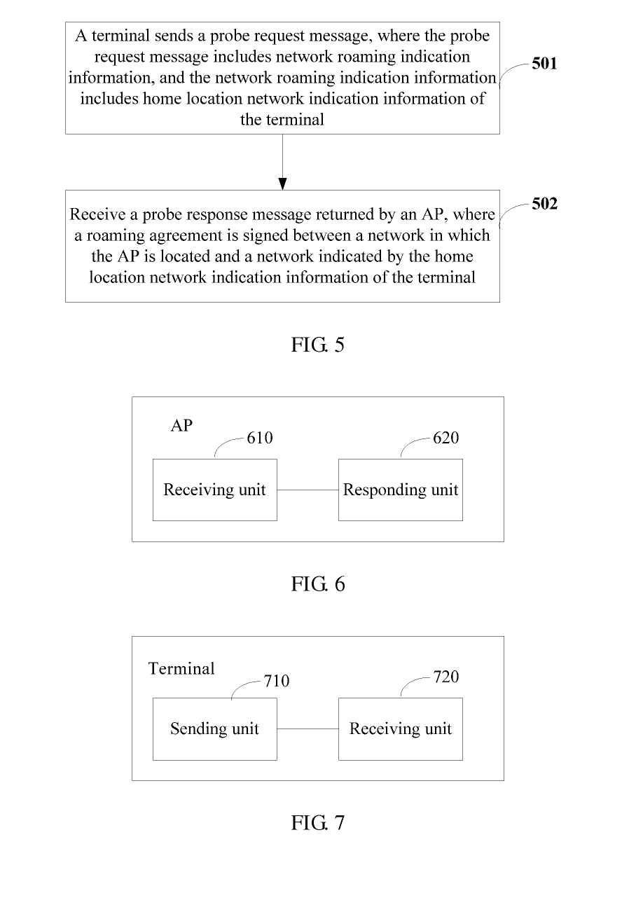

Referring to FIG. 5, FIG. 5 is a flowchart of an AP discovery method according to an embodiment of the present invention.

Step 501: A terminal sends a probe request message, where the probe request message includes network roaming indication information, and the network roaming indication information includes home location network indication information of the terminal.

To discover an AP, the terminal needs to send the probe request message. The terminal may include a SSID in the probe request message, where the SSID includes identifier information of a home location network of the terminal, or may include the SSID in the probe request message, where the SSID includes the identifier information of the home location network of the terminal and a roaming indication, or may include a roaming network information element in the probe request message, where the roaming network information element includes the identifier information of the home location network of the terminal.

Step 502: Receive a probe response message returned by an AP, where a roaming agreement is signed between a network in which the AP is located and a network indicated by the home location network indication information of the terminal.

It can be learned from the foregoing embodiment, because network roaming indication information in a probe request message carries home location network indication information of a terminal during AP discovery of the terminal, only an AP instead of all APs on a network needs to return the probe response message to the terminal, where a same network roaming agreement is signed between the network in which the AP is located and a network in which the terminal is located. Therefore, network resources are saved. In addition, it avoids that the terminal processes the probe response messages returned by the APs for which the network roaming agreement is not signed, thereby reducing time for discovering the AP by the terminal, and increasing a network access speed of the terminal accordingly.

Corresponding to the embodiments of the AP response method and the embodiment of the AP discovery method of the present invention, the present invention further provides an embodiment of an AP that implements the embodiments of the foregoing AP response method and an embodiment of a terminal that implements the embodiment of the foregoing AP discovery method.

Referring to FIG. 6, FIG. 6 is a block diagram of a first embodiment of an AP according to the present invention.

The AP includes a receiving unit 610 and a responding unit 620.

The receiving unit 610 is configured to receive a probe request message sent by a terminal, where the probe request message includes network roaming indication information, and the network roaming indication information includes home location network indication information of the terminal.

The responding unit 620 is configured to be allowed to send a probe response message to the terminal when a roaming agreement is signed between a network indicated by the home location network indication information of the terminal and a network in which the AP is located. It should be noted that, after allowing the probe response message to be returned to the terminal, the responding unit 620 may directly return the probe response message to the terminal, or the responding unit 620 may return the probe response message to the terminal again after another preset condition is met.

Specifically, the probe request message received by the receiving unit 610 includes a SSID, where the SSID includes identifier information of the home location network of the terminal. The responding unit 620 may include (not shown in FIG. 6) a first reading subunit configured to read the SSID in the probe request message and acquire the identifier information of the home location network of the terminal from the SSID, a first comparing subunit configured to, when it is determined according to the identifier information that the AP does not belong to the home location network of the terminal, check whether a roaming agreement is signed between the network indicated by the identifier information of the terminal and the network in which the AP is located, and a first responding subunit configured to allow the probe response message to be sent to the terminal when the roaming agreement is signed between the network indicated by the identifier information of the terminal and the network in which the AP is located. It should be noted that, after allowing the probe response message to be sent to the terminal, the first responding subunit may directly return the probe response message to the terminal, or the first responding subunit may return the probe response message to the terminal again after another preset condition is met.

Specifically, the probe request message received by the receiving unit 610 includes the SSID, where the SSID includes the identifier information of the home location network of the terminal and a roaming indication. The responding unit 620 may include (not shown in FIG. 6) a second reading subunit configured to read the SSID in the probe request message and acquire the identifier information of the home location network of the terminal and the roaming indication from the SSID, a second comparing subunit configured to trigger, according to the acquired roaming indication, a comparison for whether a roaming agreement is signed between the network indicated by the identifier information of the terminal and the network in which the AP is located, and a second responding subunit configured to allow the probe response message to be sent to the terminal when a roaming agreement is signed between the network indicated by the identifier information of the terminal and the network in which the AP is located. It should be noted that, after allowing the probe response message to be sent to the terminal, the second responding subunit may directly return the probe response message to the terminal, or the second responding subunit may return the probe response message to the terminal again after another preset condition is met.

Specifically, the probe request message received by the receiving unit 610 includes a roaming network information element, where the roaming network information element includes the identifier information of the home location network of the terminal. The responding unit 620 may include (not shown in FIG. 6) a third reading subunit configured to read a network information element in the probe request message and acquire the identifier information of the home location network of the terminal from the network information element, a third comparing subunit configured to check whether a roaming agreement is signed between the network indicated by the identifier information of the terminal and the network in which the AP is located, and a third responding subunit configured to allow the probe response message to be sent to the terminal when a roaming agreement is signed between the network indicated by the identifier information of the terminal and the network in which the AP is located. It should be noted that, after allowing the probe response message to be sent, the third responding subunit may directly return the probe response message to the terminal, or the third responding subunit may return the probe response message to the terminal again after another preset condition is met.

Referring to FIG. 7, FIG. 7 is a block diagram of an embodiment of a terminal according to the present invention.

The terminal includes a sending unit 710 and a receiving unit 720.

The sending unit 710 is configured to send a probe request message, where the probe request message includes network roaming indication information, and the network roaming indication information includes home location network indication information of the terminal.

The probe request message sent by the sending unit 710 includes a SSID, where the SSID includes identifier information of a home location network of the terminal, or the probe request message sent by the sending unit 710 includes the SSID, where the SSID includes the identifier information of the home location network of the terminal and a roaming indication, or the probe request message sent by the sending unit 710 includes a roaming network information element, where the roaming network information element includes the identifier information of the home location network of the terminal.

The receiving unit 720 is configured to receive a probe response message returned by an AP, where a roaming agreement is signed between a network in which the AP is located and a network indicated by the home location network indication information of the terminal.

It can be learned from the foregoing embodiment, an AP receives a probe request message sent by a terminal, where the probe request message includes network roaming indication information, and the network roaming indication information includes home location network indication information of the terminal. When a roaming agreement is signed between a network indicated by the home location network indication information of the terminal and a network in which the AP is located, the AP is allowed to return a probe response message to the terminal, so that the terminal can discover the AP. In this embodiment of the present invention, because the network roaming indication information in the probe request message carries the home location network indication information of the terminal during AP discovery of the terminal, only an AP instead of all APs on a network needs to return the probe response message to the terminal, where a same network roaming agreement is signed between the network in which the AP is located and a network in which the terminal is located. Therefore, network resources are saved. In addition, it avoids that the terminal processes the probe response messages returned by the APs for which the network roaming agreement is not signed, thereby reducing time for discovering the AP by the terminal, and increasing a network access speed of the terminal accordingly.

A person skilled in the art may clearly understand that, the technique in the embodiments of the present invention may be implemented through software and a necessary general hardware platform. Based on such an understanding, the technical solutions in the embodiments of the present invention essentially, or the part contributing to the prior art may be implemented in the form of a software product. The computer software product is stored in a storage medium, such as a read-only memory (ROM), a random access memory (RAM), a magnetic disk, or an optical disc, and includes several instructions for instructing a computer device (which may be a personal computer, a server, a network device, or the like) to perform the methods described in the embodiments of the present invention or in some parts of the embodiments of the present invention.

The embodiments in this specification are all described in a progressive manner, mutual reference may be made to the same or similar part of the embodiments, and each embodiment focuses on illustrate difference from other embodiments. In particular, for the apparatus embodiment, since it is basically similar to the method embodiment, the apparatus embodiment is described simply, and the relevant part may be obtained with reference to the part of the description of the method embodiment.

The foregoing descriptions are the implementation manners of the present invention, but are not intended to limit the protection scope of the present invention. Any modifications, equivalent substitutions and improvements made within the principle of the present invention shall fall within the protection scope of the present invention.

What is claimed is:

1. An access point (AP) response method comprising:
receiving, by an AP, a probe request message sent by a terminal, wherein the probe request message comprises network roaming indication information, and wherein the network roaming indication information comprises home location network indication information of the terminal; and
allowing, by the AP, a probe response message to be returned to the terminal when a roaming agreement is signed between a network indicated by the home location network indication information of the terminal and a network in which the AP is located.

2. The method according to claim 1, wherein the home location network indication information of the terminal comprises a service set identifier (SSID), wherein the SSID comprises identifier information of a home location network of the terminal, and wherein allowing, by the AP, a probe response message to be returned to the terminal when a roaming agreement is signed between a network indicated by the home location network indication information of the terminal and a network in which the AP is located comprises:
reading the SSID in the probe request message and acquiring the identifier information of the home location network of the terminal from the SSID;
checking whether a roaming agreement is signed between the network indicated by the identifier information and the network in which the AP is located when it is determined according to the identifier information that the AP does not belong to the home location network of the terminal; and
allowing, by the AP, the probe response message to be returned to the terminal when the roaming agreement is signed between the network indicated by the identifier information of the terminal and the network in which the AP is located.

3. The method according to claim 1, wherein the home location network indication information of the terminal comprises a service set identifier (SSID), wherein the SSID comprises identifier information of a home location network of the terminal and a roaming indication, and wherein allowing, by the AP, a probe response message to be returned to the terminal when a roaming agreement is signed between a network indicated by the home location network indication information of the terminal and a network in which the AP is located comprises:
reading the SSID in the probe request message and acquiring the identifier information of the home location network of the terminal and the roaming indication from the SSID;
triggering, according to the acquired roaming indication, a comparison to determine whether a roaming agreement is signed between the network indicated by the identifier information of the terminal and the network in which the AP is located; and
allowing, by the AP, the probe response message to be returned to the terminal when the roaming agreement is signed between the network indicated by the identifier information of the terminal and the network in which the AP is located.

4. The method according to claim 1, wherein the home location network indication information of the terminal comprises a roaming network information element, wherein the roaming network information element comprises identifier information of a home location network of the terminal, and wherein allowing, by the AP, a probe response message to be returned to the terminal when a roaming agreement is signed between a network indicated by the home location network indication information of the terminal and a network in which the AP is located comprises:
reading the roaming network information element in the probe request message and acquiring the identifier information of the home location network of the terminal from the network information element;
comparing whether a roaming agreement is signed between the network indicated by the identifier information of the terminal and the network in which the AP is located; and
allowing, by the AP, the probe response message to be sent to the terminal when the roaming agreement is signed between the network indicated by the identifier information of the terminal and the network in which the AP is located.

5. An access point (AP) discovery method comprising:
sending, by a terminal, a probe request message, wherein the probe request message comprises network roaming indication information, and wherein the network roaming indication information comprises home location network indication information of the terminal; and
receiving a probe response message from the AP, wherein a roaming agreement is signed between a network in which the AP is located and a network indicated by the home location network indication information of the terminal.

6. The method according to claim 5, wherein the home location network indication information of the terminal comprises a service set identifier (SSID), and wherein the SSID comprises identifier information of a home location network of the terminal.

7. The method according to claim 5, wherein the home location network indication information of the terminal comprises a service set identifier (SSID), and wherein the SSID comprises identifier information of a home location network of the terminal and a roaming indication.

8. The method according to claim 5, wherein the home location network indication information of the terminal comprises a roaming network information element, and wherein the roaming network information element comprises identifier information of a home location network of the terminal.

9. An access point (AP) comprising:
a receiving unit configured to receive a probe request message sent by a terminal, wherein the probe request message comprises network roaming indication information, and wherein the network roaming indication information comprises home location network indication information of the terminal; and
a responding unit configured to allow a probe response message to be returned to the terminal when a roaming agreement is signed between a network indicated by the home location network indication information of the terminal and a network in which the AP is located.

10. The AP according to claim 9, wherein the probe request message received by the receiving unit comprises a service set identifier (SSID), wherein the SSID comprises identifier information of a home location network of the terminal, and wherein the responding unit comprises:
a first reading subunit configured to read the SSID in the probe request message and acquire the identifier information of the home location network of the terminal from the SSID;
a first comparing subunit configured to, when it is determined according to the identifier information that the AP does not belong to the home location network of the terminal, check whether a roaming agreement is signed between the network indicated by the identifier information of the terminal and the network in which the AP is located; and
a first responding subunit configured to allow the probe response message to be sent to the terminal when the roaming agreement is signed between the network indicated by the identifier information of the terminal and the network in which the AP is located.

11. The AP according to claim 9, wherein the probe request message received by the receiving unit comprises a service set identifier (SSID), wherein the SSID comprises identifier information of a home location network of the terminal and a roaming indication, and wherein the responding unit comprises:
a second reading subunit configured to read the SSID in the probe request message and acquire the identifier information of the home location network of the terminal and the roaming indication from the SSID;
a second comparing subunit configured to check whether a roaming agreement is signed between the network indicated by the identifier information of the terminal and the network in which the AP is located according to the acquired roaming indication; and
a second responding subunit configured to allow the probe response message to be sent to the terminal when the roaming agreement is signed between the network indicated by the identifier information of the terminal and the network in which the AP is located.

12. The AP according to claim 9, wherein the probe request message received by the receiving unit comprises a roaming network information element, wherein the roaming network information element comprises identifier information of a home location network of the terminal, and wherein the responding unit comprises:
a third reading subunit configured to read the roaming network information element in the probe request message and acquire the identifier information of the home location network of the terminal from the network information element;
a third comparing subunit configured to check whether a roaming agreement is signed between the network indicated by the identifier information of the terminal and the network in which the AP is located; and
a third responding subunit configured to allow the probe response message to be sent to the terminal when the roaming agreement is signed between the network indicated by the identifier information of the terminal and the network in which the AP is located.

13. A terminal, wherein the terminal comprises:
a sending unit configured to send a probe request message, wherein the probe request message comprises network roaming indication information, and wherein the network roaming indication information comprises home location network indication information of the terminal; and
a receiving unit configured to receive a probe response message returned by an access point (AP), wherein a roaming agreement is signed between a network in which the AP is located and a network indicated by the home location network indication information of the terminal.

14. The terminal according to claim 13, wherein the probe request message sent by the sending unit comprises a service set identifier (SSID), and wherein the SSID comprises identifier information of a home location network of the terminal.

15. The terminal according to claim 13, wherein the probe request message sent by the sending unit comprises a service set identifier (SSID), and wherein the SSID comprises the identifier information of a home location network of the terminal and a roaming indication.

16. The terminal according to claim 13, wherein the probe request message sent by the sending unit comprises a roaming network information element, and wherein the roaming network information element comprises the identifier information of a home location network of the terminal.
